(19) United States
(12) Patent Application Publication
(10) Pub. No.: US 2008/0229343 A1
(43) Pub. Date: Sep. 18, 2008

(54) Information Carrier, as Well as a Turntable and a Device for Reading Information from and/or Writing Information Onto Such an Information Carrier

(75) Inventor: Andre Latenstein Van Voorst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/567,675

(22) PCT Filed: Aug. 3, 2004
(86) PCT No.: PCT/IB2004/051368

§ 371 Date: Feb. 9, 2006

(30) Foreign Application Priority Data
Aug. 14, 2003 (EP) 03102540.6

(51) Int. Cl. G11B 17/028; G11B 23/00

(52) U.S. Cl. 720/620; 720/695

(57) ABSTRACT

Information carrier comprising a disc (1) provided with positioning means (3) arranged to cooperate with a disc drive turntable (4) for positioning the disc on the turntable. The positioning means are movable at least in a transversal disc direction (T) relative to the disc.

### BACKGROUND OF THE INVENTION

The invention relates to an information carrier comprising a disc provided with positioning means which are arranged to cooperate with a disc drive turntable for positioning the disc on the turntable.

The invention further relates to a turntable.

Such an information carrier and turntable are known from practice. The information carrier may comprise, for example, a compact disc, a small form factor disc (SFF disc), or the like. The positioning means of the known information carrier comprise a central disc aperture. The known turntable comprises a fixed positioning shaft. During use, the disc is positioned on the turntable in that the disc is placed on the turntable such that said turntable shaft extends through said central disc aperture.

A problem of the known information carrier and the known turntable is that the disc has to be moved in an axial direction onto said turntable shaft when loading the disc into the respective disc playing and/or writing device. The same applies to the unloading of the information carrier. Consequently, a lot of space is required for the loading and unloading of the information carrier. For example, the disc is inserted horizontally into the loading mechanism of a regular half-height disc drive, after which the turntable with the turntable shaft is moved upward. In one other known loading mechanism, of a notebook computer, the disc is placed manually in a vertical direction onto the turntable, after which the turntable is inserted into the computer housing by a horizontal movement. In both mechanisms, consecutive horizontal and vertical movements are required for loading the information carrier. This is particularly disadvantageous for the case in which small form factors are desired, for example in miniaturized appliances, portable devices, and the like.

### SUMMARY OF THE INVENTION

It is an object of the invention to provide an information carrier comprising a disc which can be accurately positioned on a respective turntable without needing a large amount of positioning space.

This object is achieved by the information carrier according to the invention, which carrier comprises a disc provided with positioning means which are arranged to cooperate with a disc drive turntable for positioning the disc on the turntable and which are at least movable relative to the disc in a transversal disc direction.

According to the present invention, said positioning means of the disc are at least movable in a transversal disc direction relative to the disc. Thus, the information carrier can be loaded onto a suitable turntable, for example by moving the information carrier in a longitudinal disc direction. After the information carrier disc and said turntable have been brought together, said positioning means are simply moved in a transversal disc direction relative to the disc for cooperation with the turntable, so that the positioning means and the turntable can position the disc as desired. The movement of the positioning means, consequently, does not have to involve a transversal movement of the disc itself. Therefore, the information carrier needs little space during the loading thereof. The unloading of the information carrier can be achieved by carrying out the above steps in reverse order.

The invention further provides a turntable which is characterized by the features of claim 12. Since the turntable is suitable for cooperation with the positioning means of an information carrier according to any of claims 1-11, the loading and/or unloading as well as the positioning of the information carrier can be carried out in a small area.

According to an embodiment of the invention, a turntable comprising a shaft for positioning a disc of an information carrier by a respective disc aperture is characterized in that said disc positioning shaft is substantially movable in an transversal direction with respect to a disc supporting surface of the turntable.

In this case it is the turntable, not the information carrier, which comprises transversally movable positioning means for positioning the disc on said disc supporting surface. The invention is based on the same inventive concept as above, making use of transversally movable positioning means. To load the disc, the disc positioning shaft is retracted into the turntable so that said disc supporting surface is substantially clear from any obstacles. In that situation the information carrier can be moved onto the turntable in a substantially longitudinal disc direction, so that the loading of the disc can be accomplished in a small loading space. When the disc has been properly placed onto the turntable, said positioning shaft can simply be moved in said transversal direction from the turntable into said disc aperture for an accurate positioning of the disc. The movement of the positioning shaft can be achieved with relatively simple means, for example using an actuator, magnetic force, or the like. Such a movable shaft is also relatively durable. A further advantage of this turntable is that the respective information carriers can be made relatively cheap and straightforward, each with a positioning aperture for positioning the disc on the shaft.

Besides, the present invention provides a device for reading information from and/or writing information onto an information carrier, which is characterized by the features of claim 16. Such a device benefits from the abovementioned advantages of said turntable. The reading and/or writing device can be utilized in many different appliances, for example computers, portable apparatuses, audio and/or video devices, and the like.

Further advantageous embodiments of the invention are described in the dependent claims.

The invention will now be described in more detail on the basis of exemplary embodiments shown in the accompanying drawing.

### BRIEF DESCRIPTION OF THE DRAWING

FIG. 1 is a cross-section of a first embodiment of an information carrier according to the invention;

FIG. 2 is a cross-section of a second embodiment of an information carrier according to the invention;

FIG. 3 is a cross-section showing the loading of said first embodiment of FIG. 1 onto a respective turntable;

FIG. 4 is a cross-section showing the loading of a third embodiment of an information carrier onto a respective turntable; and

FIG. 5 is a cross-section showing the loading of a fourth embodiment of an information carrier onto a respective turntable.

### DETAILED DESCRIPTION OF THE PREFERRED EMBODIMENTS

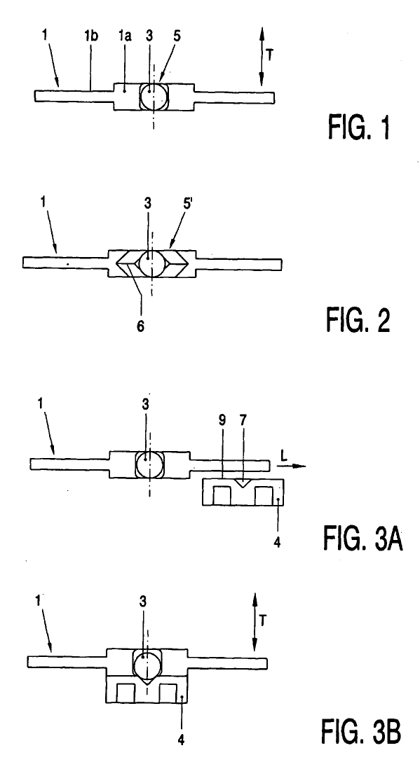

FIG. 1 schematically shows a cross-section of a first embodiment of an information carrier, comprising a disc 1. A central part 1a of the disc 1 is provided with a substantially cylindrical aperture 5, snugly accommodating a movable positioning element 3. Said positioning element 3 of the first embodiment is a ball 3 which is movable in a transversal disc direction T with respect to an information carrying disc part 1b. The transversal ends of the cylindrical aperture 5 are somewhat contracted for retaining said positioning ball 3. FIG. 1 shows a first transversal position of said ball 3.

FIG. 3 shows the use of the first embodiment of the information carrier in combination with a turntable 4. The turntable 4 is arranged to cooperate with said positioning ball 3 of the information carrier disc 1. More specifically, the turntable 4 comprises a respective positioning means, being a substantially conical positioning aperture 7, which is provided in a disc supporting surface 9 of the turntable 4. As is shown in FIGS. 3A and 3B, the disc 1 is moved during loading in a substantially longitudinal disc direction L into a position in which said central disc part 1a is placed on the disc carrying surface of the turntable 4, such that the ball 3 of the disc 1 is aligned with the aperture 7 of the turntable 4. Then the positioning ball 3 of the disc 1 is moved transversally from said first position into a second transversal position in which the ball 3 projects partially from the disc 1 and into said positioning aperture 7 of the turntable 4, leading to a precise disc positioning with respect to the turntable 4. Said second ball position is shown in FIG. 3B. The ball 3 is retained in said second ball position, so the disc 1 can be rotated by the turntable 4, for example to read information from the disc 1 and/or write information onto the disc 1, while said precise positioning of the disc 1 is upheld by the cooperation between said positioning element 3 of the disc 1 and said positioning cavity 7 of the turntable 4.

The advantage of using a ball 3 as a positioning element is that there is relatively little friction between the ball 3 and the disc 2, allowing easy transversal movement of he ball 3. Besides, the spherical shape of this positioning element 3 provides for an automatic, precise repositioning of the disc 3 during the movement of the ball 3 towards said second ball position if the ball 3 is not perfectly aligned with the positioning aperture 7 of the turntable 4. Such a repositioning is achieved, for example, under the influence of the force which attracts the ball 3 into said conical positioning aperture 7 during the longitudinal movement of the disc. Furthermore, the turntable 4 shown in FIG. 3 does not comprise a positioning shaft extending from said disc supporting surface 9, so that it suffices to move the disc 1 in said substantially longitudinal direction L for loading the disc 1. Also, the disc 1 can be removed from the turntable 4 with ease, during which the positioning ball 3 can simply roll out of the respective turntable aperture 7.

Said transversal movement of said positioning means 3 as well as the maintenance of these positioning means in said second transversal position can be achieved in different ways. According to a relatively simple embodiment, a magnetic force can move and retain the positioning means 3. For example, said turntable may comprise a magnet 8 for attracting said positioning element 3, provided that the positioning element 3 contains a suitable material.

FIG. 2 shows an alternative embodiment of an information carrying disc 1, comprising a relatively large aperture 5′ comprising a positioning ball 3. In this embodiment, said positioning element 3 is movably retained in the center of the aperture 5′ by spring means 6, for example one or more leaf springs.

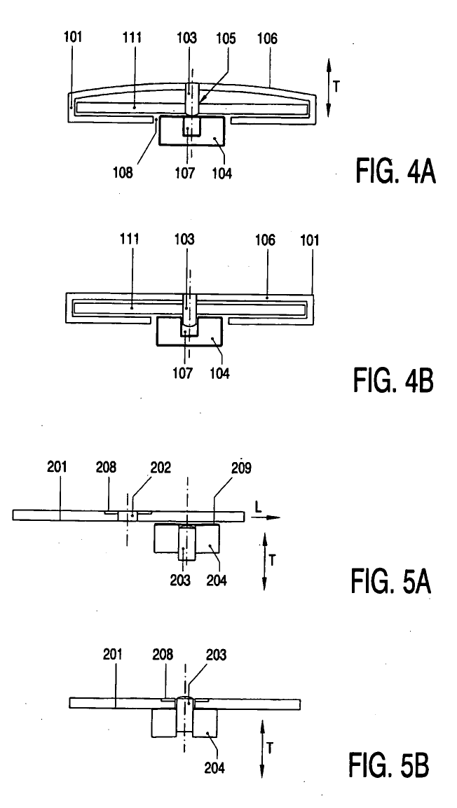

FIGS. 4A and 4B show a third embodiment of the invention, wherein the information carrier comprises a cassette 101 containing a disc 111 for carrying information. A respective turntable 104 for rotating said disc 111 is also shown in these FIGS. 4A, 4B. The cassette 101 may serve to protect to the disc 11 contained therein. As is shown in FIG. 4A, the third embodiment comprises a positioning shaft 103 which extends through a central aperture 105 of said disc 111. The positioning shaft 103 is axially movable, in the transversal disc direction T with respect to the disc 111, from a first shaft position shown in FIG. 4A to a second shaft position shown in FIG. 4B. In the second shaft position, the shaft 103 reaches outward from a disc surface for cooperation with said turntable 104. The cassette 101 is provided with a gap 108 for exposing said disc surface and the positioning shaft 103 to the turntable 104.

In this third embodiment, said cassette 101 is arranged for moving the positioning shaft 103. This is simply achieved by a movable cassette part 112 which is connected to said positioning shaft 103. Movement of said movable cassette part 112, for example under the influence of an external force, leads to the axial movement of the positioning shaft 103. Said movement of the cassette part 112 may be achieved, for example, by an external mechanical force acting thereon during the loading of the cassette towards the turntable 104. The advantage of a transversally movable positioning shaft 103, as shown in FIGS. 4A, 4B, is that the shaft is retained substantially by itself in said second shaft position during rotation of the disc 111 and the turntable 104.

More particularly, the cassette 101 comprises a resilient wall part 106 extending alongside the disc 111. The disc positioning shaft 103 is connected to this wall part 106 by a shaft end. The resilient wall part 106 is slightly bent away from the disc 1, such that the wall part 106 retains the positioning shaft 103 in said first shaft position if substantially no mechanical force is applied to said wall part 106. When the cassette has been loaded towards the turntable 104, as is shown in FIG. 4B, the resilient wall part 106 is pushed towards the disc 1 by an external force, so that the positioning shaft 103 is moved towards the second shaft position for cooperation with a respective positioning aperture 107 of the turntable 104. The positioning shaft 103 can be simply retracted from said turntable aperture 107 by a removal of said external force.

FIGS. 5A and 5B show a fourth embodiment of the invention, comprising an information carrier 201 and a respective turntable 204. In this fourth embodiment, the information carrier comprises a disc 201 provided with a positioning aperture 202, and the turntable comprises a movable positioning shaft 203. Said shaft 203 is axially movable, in an transversal direction T with respect to a disc supporting surface 209 of the turntable 204. In a retracted position of the shaft shown in FIG. 5A, the disc supporting surface 209 is free from obstacles. As is shown in FIGS. 5A, 5b, the disc 201 is moved during use in a substantially longitudinal disc direction L onto the disc supporting surface 209 of the turntable 204, such that said shaft 203 and said disc aperture 202 are aligned. Then the positioning shaft 203 of the turntable is moved into the disc aperture 202 for positioning the disc 201. Movement of the positioning shaft 203 of this embodiment can be achieved in different ways, for example by magnetic force, by an actuator, or the like. The disc 201 may comprise, for example, a magnetic means, shown in the Figure as a magnet ring 208, for attracting the turntable shaft 203. Preferably, said positioning shaft 203 of the turntable 204 has a diameter of about 5 mm or less, particularly about 1 mm or less. In that case, small form factors can be achieved in the construction of the turntable 204 and of a device comprising such a turntable 204. In the same way, the respective disc aperture 203 of the disc 201 may have a small diameter of about 5 mm or less, particularly about 1 mm or less.

Although the illustrative embodiments of the present invention have been described in greater detail with reference to the accompanying drawing, it is to be understood that the invention is not limited to those embodiments. Various changes, modifications or combinations may be effected by those skilled in the art without departing from the scope or the spirit of the invention as defined in the claims.

Said positioning means may be moved in a transversal disc direction by different forces acting thereon, for example by magnetic force, by gravity, by an elastic force, a spring force, by combinations of such forces, and/or by means of other forces. Said magnetic force may be produced, for example, by one or more permanent magnets, an electric motor for rotating the turntable, and/or electromagnets. Moreover, the information carrier may comprise magnetic means, such as a permanent magnet and/or magnetic conductor material, for obtaining a suitable magnetic field.

Besides, the positioning means may comprise, for example, a flexible part of said disc.

The positioning element may have various shapes and dimensions. For example, a small form factor positioning element, for example a small spherical or cylindrical shaft, may have a diameter of about 5 mm or less, more specifically about 1 mm or less.

Furthermore, the positioning means are movable in a transversal disc direction T relative to the disc, and may also be movable in different directions.

The information carrier may be provided in a variety of shapes and dimensions. Preferably, said disc also has a small form factor, for example a disc having a diameter of about 3 cm or less. Information may be carried in various ways by said disc, for example optically, magnetically, or otherwise. The disc may already carry such information. Besides, the disc may be arranged to be provided with information, for example by means of a disc writing device.

The turntable may be arranged in several ways. The turntable may, for example, comprise clamping means for clamping the information carrier to the table. Such clamping means may be arranged to clamp the disc against the turntable after the disc has been properly positioned by said positioning means.

Besides, the information carrier and/or said disc may have various shapes, for example round, angular, or other shapes.

1. Information carrier comprising a disc (1; 111) provided with positioning means (3; 103) which are arranged to cooperate with a disc drive turntable (4; 104) for positioning the disc (1; 111) on the turntable (4; 104) and which are at least movable relative to the disc (1; 111) in a transversal disc direction (T).

2. Information carrier according to claim 1, wherein said positioning means (3; 103) are at least movable between a first position wherein the positioning means are substantially located within the information carrier and a second position wherein the positioning means project at least partially from a side of the information carrier.

3. Information carrier according to claim 2, wherein the information carrier comprises means (6; 106) for moving said positioning means (3; 103) towards said first position.

4. Information carrier according to claim 1, wherein said movable positioning means (3; 103) extend at least partially into an aperture (5; 105) of said disc (1).

5. Information carrier according to claim 1, wherein said positioning means comprise a movable positioning element (3; 103).

6. Information carrier according to claim 5, wherein said positioning element (3) is a spherical element (3), for example a ball.

7. Information carrier according to claim 1, wherein a central part (1a) of said disc (1) comprises said positioning means (3).

8. Information carrier according to claim 1, wherein said positioning means (3) are arranged to be moved by a magnetic field.

9. Information carrier according to claim 1, wherein the information carrier comprises a cassette (101) containing said disc (111).

10. Information carrier according to claim 9, wherein said cassette (101) is arranged for moving the positioning means (103) in said transversal disc direction (T).

11. Information carrier according to claim 10, wherein said cassette (101) comprises a movable cassette part (106) which is connected to said positioning means (103) for the movement thereof.

12. Turntable suitable for cooperation with the positioning means (3; 103) of an information carrier according to claim 1.

13. Turntable according to claim 12, comprising a positioning aperture (7; 107) for receiving at least part of said positioning means (3; 103) of the information carrier for positioning said disc (1; 111).

14. Turntable comprising a shaft (203) for positioning a disc (201) of an information carrier by means of a respective disc aperture (202), which disc positioning shaft (203) is substantially movable in a transversal direction with respect to a disc supporting surface (209) of the turntable (204).

15. Turntable according to claim 14, wherein said shaft (203) has a diameter of about 5 mm or less, particularly about 1 mm or less.

16. Device for reading information from and/or writing information onto an information carrier, comprising at least one turntable according to claim 12.
